(19) United States
(12) Patent Application Publication
(10) Pub. No.: US 2017/0277395 A1
(43) Pub. Date: Sep. 28, 2017

(54) CONTROL METHOD FOR TERMINAL AND TERMINAL

(71) Applicants: Le Holdings (Beijing) Co., Ltd., Beijing (CN); Lemobile Information Technology (Beijing) Co., Ltd., Beijing (CN)

(72) Inventor: Haosen Suo, Beijing (CN)

(21) Appl. No.: 15/335,416

(22) Filed: Oct. 26, 2016

Related U.S. Application Data
(63) Continuation of application No. PCT/CN2016/096430, filed on Aug. 23, 2016.

(30) Foreign Application Priority Data
Mar. 25, 2016 (CN) 2016101802579

(51) Int. Cl. G06F 3/0481; G06F 3/0484; G06F 3/0488

(52) U.S. Cl. CPC G06F 3/04817; G06F 3/04883; G06F 3/04845; G06F 3/0482

(57) ABSTRACT

The embodiments of the present disclosure provide a control method for a terminal and the terminal. On the one hand, the control method comprises: acquiring operation information of a user operated at an edge touch area of the terminal; and hiding a specified desktop icon according to the operation information of the user at the edge touch area of the terminal. The technical solutions provided by the embodiments of the present disclosure are used for solving the problem of low operation efficiency caused by setting a private mode for user's private contents in the prior art, are simple and convenient in operation, and improve the operation efficiency.

### CROSS REFERENCE TO RELATED APPLICATIONS

The present disclosure is a continuation of International application No. PCT/CN2016/096430, filed on 23 Aug. 2016 which is based upon and claims the priority of Chinese Disclosure No. 2016101802579, filed in Chinese Patent Office on Mar. 25, 2016, and entitled “CONTROL METHOD FOR TERMINAL AND TERMINAL”, the entire contents of which are herein incorporated by reference.

### TECHNICAL FIELD

The present disclosure relates to the technical field of communications, and particularly relates to a control method for a terminal and the terminal.

### BACKGROUND

Current mainstream terminals adopt touch screens, and users can control the terminals by operating functional keys on the touch screens. When a user uses a terminal, if he does not want other users to see some contents including files, pictures, videos, disclosures or the like in the terminal, he needs to set access authorities for these private contents, so as to protect his own privacy.

In the process of implementing the present disclosure, the inventor discovers that the prior art at least has the following problems: in the prior art, the user generally sets access authorities for private contents including files, pictures, videos, disclosures or the like by encrypting these user's private contents one by one or setting a guest mode for the terminal; and after a private mode is set for these user's private contents via the above means, when these user's private contents are accessed, it needs to input a password or change the running mode of the terminal via setting, so the operation process is tedious. Thus, low operation efficiency may be caused by setting the private mode for user's private contents in the prior art.

### SUMMARY

In view of this, the present disclosure provides a control method for a terminal and the terminal for solving the problem of low operation efficiency caused by setting a private mode for user's private contents in the prior art.

To fulfill the above invention aim, in the first aspect, an embodiment of the present disclosure provides a control method for a terminal, including: acquiring operation information of a user operated at an edge touch area of the terminal; and hiding a specified desktop icon according to the operation information of the user at the edge touch area of the terminal.

In the second aspect, an embodiment of the present disclosure provides a control method for a terminal, including: acquiring operation information of a user operated at an edge touch area of the terminal; and displaying a desktop icon hidden in the terminal via a screen of the terminal according to the operation information of the user at the edge touch area of the terminal.

in the third aspect, an embodiment of the present disclosure provides a terminal, including at least one processor and a memory in communication connection with the at least one processor, wherein the memory stores an instruction which can be executed by the at least one processor, and the instruction is executed by the at least one processor, so that the at least one processor can: acquire operation information of a user at an edge touch area of the terminal; and hide a specified desktop icon according to the operation information of the user at the edge touch area of the terminal.

In the fourth aspect, an embodiment of the present disclosure provides a terminal, including at least one processor and a memory in communication connection with the at least one processor, wherein the memory stores an instruction which can be executed by the at least one processor, and the instruction is executed by the at least one processor, so that the at least one processor can: acquire operation information of a user at an edge touch area of the terminal; and display a desktop icon hidden in the terminal via a screen of the terminal according to the operation information of the user at the edge touch area of the terminal.

In the fifth aspect, an embodiment of the present disclosure provides a non-transient computer readable storage medium, which stores a computer executable instruction used for: acquiring operation information of a user operated at an edge touch area of a terminal; and hiding a specified desktop icon according to the operation information of the user at the edge touch area of the terminal.

In the sixth aspect, an embodiment of the present disclosure further provides a non-transient computer readable storage medium, which stores a computer executable instruction used for: acquiring operation information of a user operated at an edge touch area of a terminal; and displaying a desktop icon hidden in the terminal via a screen of the terminal according to the operation information of the user at the edge touch area of the terminal.

In the ninth aspect, an embodiment of the present disclosure provides a computer program product, the computer program product includes a computer program stored on a non-transient computer readable storage medium, the computer program includes a program instruction, and when the program instruction is executed by a computer, the computer executes the methods of the first aspect, the third aspect, the fifth aspect and the seventh aspect.

### BRIEF DESCRIPTION OF DRAWINGS

One or more embodiments are illustrated exemplarily via pictures in corresponding drawings, these exemplary illustrations do not limit the embodiments, elements with the same reference numerical signs in the drawings are similar ones, and the pictures in the drawings do not have scale limitations unless otherwise specified.

FIG. 1 is a flow schematic diagram of embodiment 1 of a control method for a terminal provided by an embodiment of the present disclosure;

FIG. 2 is a flow schematic diagram of embodiment 2 of a control method for a terminal provided by an embodiment of the present disclosure;

FIG. 3 is a flow schematic diagram of embodiment 3 of a control method for a terminal provided by an embodiment of the present disclosure;

FIG. 4 is a structural schematic diagram of embodiment 1 of a terminal provided by an embodiment of the present disclosure;

FIG. 5 is a structural schematic diagram of embodiment 2 of a terminal provided by an embodiment of the present disclosure;

FIG. 6 is a schematic diagram of a hardware structure of a terminal for executing a control method for the terminal provided by an embodiment of the present disclosure;

FIG. 7 is a schematic diagram of a hardware structure of a terminal for executing a control method for the terminal provided by an embodiment of the present disclosure.

### DETAILED DESCRIPTION

Preferred embodiments of the present disclosure will be described below in combination with the accompanying drawings. It should be understood that the preferred embodiments described herein are merely used for describing and interpreting the present disclosure, rather than limiting the present disclosure.

It should be clear that the described embodiments are merely part of, not all of the embodiments of the present disclosure. All of other embodiments obtained by those of ordinary skill in the art without any creative effort based on the embodiments in the present disclosure shall fall into the protection scope of the present disclosure.

The terms used in the embodiments of the present disclosure are intended for describing specific embodiments only, rather than limiting the present disclosure. Singular forms “a”, “the” and “said” used in the embodiments and the appended claims of the present disclosure are also intended to include plural forms, unless other meanings are clearly expressed in the context.

It should be understood that the term “and/or” used herein is merely an association relation for describing associated objects, and can express three relations, for example, A and/or B can express: existence of only A, existence of both A and B, and existence of only B. In addition, the symbol “/” herein generally expresses an “or” relation between front and back associated objects.

Depending on the context, the word “if” used herein can be interpreted as “at the time of” or “when” or “in response to determining” or “in response to detecting”. Similarly, depending on the context, the phrase “if determining” or “if detecting (the stated condition or event)” can be interpreted as “when determining” or “in response to determining” or “when detecting (the stated condition or event)” or “in response to detecting (the stated condition or event)”.

### Embodiment 1

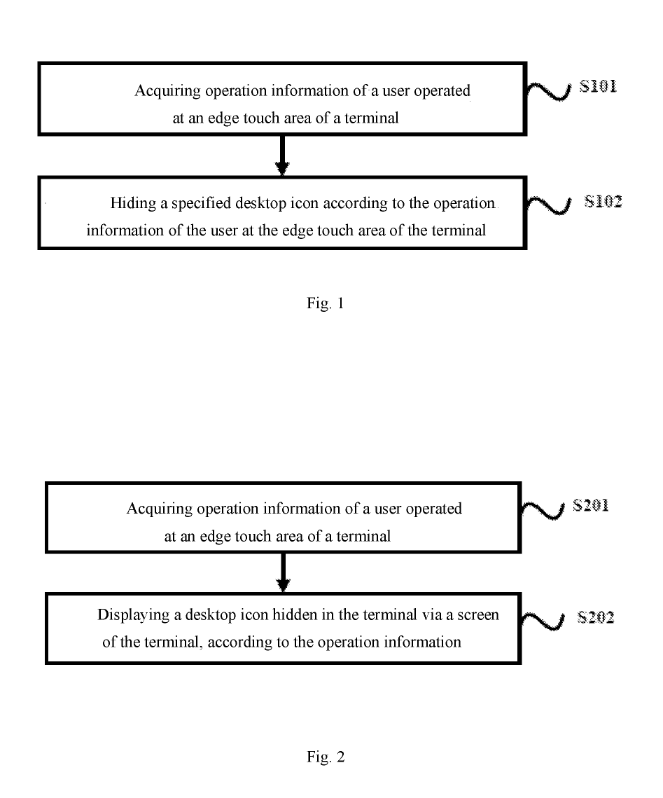

The embodiment of the present disclosure provides a control method for a terminal. Please refer to FIG. 1, which is a flow schematic diagram of embodiment 1 of a control method for a terminal provided by an embodiment of the present disclosure. As shown in FIG. 1, the method includes the following steps S101˜S102.

S101, acquiring operation information of a user operated at an edge touch area of the terminal.

Specifically, the terminal acquires the operation information of the user at the edge touch area of the terminal in order to judge whether a specified desktop icon can be hidden according to the operation information.

It should be noted that the terminal involved in the embodiment of the present disclosure may include but not limited to a personal computer (PC), a personal digital assistant (PDA), a wireless handheld device, a tablet computer, a mobile phone, an MP3 player, an MP4 player, etc.

It could be understood that edge touch refers to that touch input is provided via the edge or the border of the terminal to track clicking, sliding or pressing of a finger on the edge of the terminal so as to control the mobile phone.

The edge touch area of the terminal may be an area that the thumb of the user can reach on the sides of the terminal when the user naturally holds the terminal, and the sides of the terminal include other four sides except the front and the back.

Specifically, the edge touch area of the terminal includes an edge touch area of at least one side on the terminal.

In the embodiment of the present disclosure, the edge touch area of the terminal may be realized by physical keys, virtual keys, sensors or a screen.

For example, if the terminal uses a curved screen, the edge touch area of the terminal can be realized by the edge screen of the curved screen. Taking a capacitive touch screen as an example for illustration, when the finger of the user touches the edge touch screen, the capacitance of the contact is changed, so that the oscillator frequency related with the capacitance is changed, the touch position can be determined by measuring the change of the oscillator frequency, and then the operation information of the user at the edge touch area of the terminal can be acquired.

Or, as another example, the edge touch area of the terminal has no curved screen, and its operation can be realized by a physical key, a virtual key or a sensor. If a physical key for adjusting the volume is at the edge of the terminal, taking the physical key for adjusting the volume in the terminal as an example for illustration, when the finger of the user presses the physical key for adjusting the volume, the terminal may learn that which key the user has pressed, the key for turning up the volume or the key for turning down the volume, thereby acquiring the operation information of the user at the edge touch area of the terminal. If virtual keys with certain functions are at the edge of the terminal, taking the virtual keys on the terminal as an example, when the virtual keys are capacitive virtual keys, the terminal judges which virtual key the user touches via the capacitance of the capacitive virtual keys, specifically, the finger and an electrode plate in the capacitive virtual key may form a capacitor when the user touches a capacitive virtual key, and the terminal detects the change of the capacitance to determine the touch position of the user so as to determine which virtual key the user touches and then acquire the operation information of the user at the edge touch area of the terminal. If sensors with certain functions are at the edge of the terminal, taking the sensors which are pressure sensors on the terminal as an example, when the user presses a pressure sensor, semiconductor deformation pressure is formed on the flaky surface of the pressure sensor, the flaky surface is deformed by pressing to produce a piezoelectric impedance effect, the change of the impedance is converted into an electrical signal, and the terminal can determine which pressure sensor the user presses or which position on the pressure sensor the user presses after acquiring the electrical signal, then determine the pressure sensor of which function the user presses and acquire the operation information of the user at the edge touch area of the terminal. Further, the sensors with certain functions at the edge of the terminal may also be optical inductors.

In the embodiment of the present disclosure, acquiring operation information of a user operated at an edge touch area of the terminal includes the following method: acquiring operation information, performed on the terminal and related to the edge touch area of the terminal, of the user; and/or acquiring operation information, performed on the edge touch area of the terminal, of the user.

I, acquiring operation information, performed on the terminal and related to the edge touch area of the terminal, of the user may include but not limited to: monitoring whether a desktop icon on the terminal is dragged to the edge touch area of the terminal.

In the embodiment of the present disclosure, monitoring whether a desktop icon on the terminal is dragged to the edge touch area of the terminal is to judge whether a specified desktop icon can be hidden.

Specifically, the terminal can monitor the specific desktop icon dragged to the edge touch area of the terminal, and the desktop icon dragged to the edge touch area of the terminal is the specified desktop icon.

For example, if the terminal monitors that the desktop icon of WeChat is dragged to the edge touch area of the terminal by the user, it regards the desktop icon of WeChat as a specified desktop icon; if the terminal monitors that the desktop icon of Microblog is dragged to the edge touch area of the terminal by the user, it regards the desktop icon of Microblog as a specified desktop icon; and if the terminal monitors that both the desktop icon of WeChat and the desktop icon of Microblog are dragged to the edge touch area of the terminal by the user, it regards the desktop icon of WeChat and the desktop icon of Microblog as specified desktop icons.

II, acquiring operation information, performed on the edge touch area of the terminal, of the user may include but not limited to: detecting the operation information, performed on the edge touch area of the terminal, of the user, and comparing the operation information of the user at the edge touch area of the terminal with preset specified operation information for hiding a specified desktop icon, thereby judging whether the operation information of the user at the edge touch area of the terminal is the specified operation information for hiding the specified desktop icon.

In the embodiment of the present disclosure, detecting whether the operation information of the user at the edge touch area of the terminal is specified operation information for hiding the specified desktop icon is to judge whether the specified desktop icon is hidden.

In the embodiment of the present disclosure, the specified desktop icon in the terminal can be preset according to actual needs.

Specifically, the user can preset the desktop icon corresponding to the content of a file, a picture, a video, an disclosure or the like in a running state or an opened state at present as a specified desktop icon. For example, the specified desktop icon may include but not limited to: a desktop icon corresponding to a running disclosure in the terminal, a desktop icon corresponding to an opened picture in the terminal, a desktop icon corresponding to an opened file in the terminal, a desktop icon corresponding to a played video in the terminal, and a desktop icon corresponding to a played music in the terminal.

For example, if the terminal presets the desktop icon corresponding to the content of a file, a picture, a video, an disclosure or the like in a running state or an opened state at present as a specified desktop icon, when the terminal detects an operation of the user at the edge touch area of the terminal and is running WeChat, it regards the desktop icon of WeChat as the specified desktop icon.

Specifically, the terminal may preset the desktop icon corresponding to the content of a file, a picture, a video, an disclosure or the like in a hidden state or a private mode as a specified desktop icon. In a specific implementation process, the terminal does not consider whether the desktop icon corresponding to the content of a file, a picture, a video, an disclosure or the like in a hidden state or a private mode is in a running state or an opened state, but regards a desktop icon corresponding to the content of a file, a picture, a video, an disclosure or the like in a hidden state or a private mode in a running state or an opened state as the specified desktop icon.

For example, if the terminal presets the desktop icon corresponding to the content of a file, a picture, a video, an disclosure or the like in a hidden state or a private mode as a specified desktop icon, the terminal has set WeChat, Microblog or Zhihu in a private mode, and no matter whether WeChat, Microblog or Zhihu is in a running state, the terminal regards the desktop icon of WeChat, the desktop icon of Microblog or the desktop icon of Zhihu corresponding to WeChat, Microblog or Zhihu as a specified desktop icon.

In the embodiment of the present disclosure, acquiring operation information of a user operated at an edge touch area of the terminal may include: acquiring operation information of the user on a valid area of the edge touch area of the terminal. Only the operation in the valid area can fulfill the purpose of hiding the specified desktop icon.

In the embodiment of the present disclosure, the operation information of the user at the edge touch area of the terminal may include but not limited to: operation information generated after sliding operation of the user at the edge touch area of the terminal; or operation information generated after clicking operation of the user at the edge touch area of the terminal; or operation information generated after pressing operation of the user at the edge touch area of the terminal.

III: acquiring operation information, performed on the terminal and related to the edge touch area of the terminal, of the user, and acquiring operation information, performed on the edge touch area of the terminal, of the user.

In the embodiment of the present disclosure, acquiring operation information at an edge touch area of the terminal may also include: simultaneously acquiring operation information, performed on the terminal and related to the edge touch area of the terminal, of the user, and operation information, performed on the edge touch area of the terminal, of the user.

S102, hiding a specified desktop icon according to the operation information of the user at the edge touch area of the terminal.

Specifically, the user can hide the specified desktop icon by operating the edge touch area of the terminal.

In the embodiment of the present disclosure, the step that the specified desktop icon is hidden in the terminal includes: not displaying the specified desktop icon in the desktop of the terminal, but still saving the content of the file, picture, video, disclosure or the like corresponding to the specified desktop icon in the terminal. However, in the process of using the terminal by the user, the user still can find the content corresponding to the hidden specified desktop icon by some complex operation, e.g., using an disclosure management menu, a setting menu or the like. For example, the user can put the desktop icons corresponding to these private contents into a private folder, while the private folder is not displayed in the desktop of the terminal.

In the embodiment of the present disclosure, the methods for hiding a specified desktop icon according to the operation information of the user at the edge touch area of the terminal may include but not limited to the following two methods.

Method one: if the terminal monitors that the desktop icon on the terminal is dragged to the edge touch area of the terminal, hiding the dragged desktop icon.

For example, if the terminal monitors that the user drags the desktop icon of WeChat to the edge touch area of the terminal, the terminal regards the desktop icon of WeChat as a specified desktop icon and hides it therein.

Method two: if the terminal detects that the operation information of the user at the edge touch area of the terminal is specified operation information for hiding the specified desktop icon, hiding the specified desktop icon.

Otherwise, if the terminal determines that the operation information of the user at the edge touch area of the terminal is not specified operation information for hiding the specified desktop icon, the desktop icon is not hidden, and the display state of the specified desktop icon is kept.

For example, the specified desktop icon of the terminal is the desktop icon of WeChat, and the specified operation information preset by the terminal for hiding the specified desktop icon is operation information generated after upward sliding of the user at the edge touch area of the terminal. If the terminal detects that the operation information of the user at the edge touch area of the terminal is upward sliding, the terminal compares the acquired operation information with preset operation information to determine that the operation information generated after upward sliding of the user at the edge touch area of the terminal is the specified operation information for hiding the desktop icon of WeChat, and the terminal hides the desktop icon of WeChat. Otherwise, if the terminal detects that the operation information of the user at the edge touch area of the terminal is leftward sliding, the terminal compares the acquired operation information with preset operation information to determine that the operation information generated after leftward sliding of the user at the edge touch area of the terminal is not the specified operation information for hiding the desktop icon of WeChat, and the terminal does not hide the desktop icon of WeChat but keeps the display state of the desktop icon of WeChat.

The technical solution of the embodiment of the present disclosure has the following advantages: in the embodiment of the present disclosure, operation information of a user at an edge touch area of the terminal is acquired, and then a specified desktop icon is hidden according to the operation information of the user at the edge touch area of the terminal. In the embodiment of the present disclosure, when a user sets a private mode for some private contents, he only needs to carry out simple operation at the edge touch area of the terminal, and then the terminal hides the desktop icons corresponding to these user's private contents therein; thus, the user can simply and quickly set a private mode for some private contents, and the desktop icons corresponding to these contents are simultaneously guaranteed not to be perceived by other users. Hence, the embodiment of the present disclosure solves the problem of low operation efficiency caused by setting a private mode for user's private contents in the prior art, is simple and convenient in operation, and improves the operation efficiency.

### Embodiment 2

The embodiment of the present disclosure provides a control method for a terminal. Please refer to FIG. 2, which is a flow schematic diagram of embodiment 2 of a control method for a terminal provided by an embodiment of the present disclosure. As shown in FIG. 2, the method includes the following steps S201˜S202.

S201, acquiring operation information of a user operated at an edge touch area of the terminal.

Specifically, acquiring the operation information of the user at the edge touch area of the terminal is to judge whether a desktop icon hidden in the terminal can be displayed via a screen of the terminal, according to the operation information.

It should be noted that the terminal involved in the embodiment of the present disclosure may include but not limited to a personal computer (PC), a personal digital assistant (PDA), a wireless handheld device, a tablet computer, a mobile phone, an MP3 player, an MP4 player, etc.

In the embodiment of the present disclosure, the operation information of the user at the edge touch area of the terminal may include but not limited to: operation information generated after sliding operation of the user at the edge touch area of the terminal; or operation information generated after clicking operation of the user at the edge touch area of the terminal; or operation information generated after pressing operation of the user at the edge touch area of the terminal.

It could be understood that edge touch refers to that touch input is provided via the edge or the border of the terminal to track clicking, sliding or pressing of a finger on the edge of the terminal so as to control the mobile phone.

The edge touch area of the terminal may be an area that the thumb of the user can reach on the sides of the terminal when the user naturally holds the terminal, and the sides of the terminal include other four sides except the front and the back.

In the embodiment of the present disclosure, the edge touch area of the terminal includes an edge touch area of at least one side on the terminal.

In the embodiment of the present disclosure, the edge touch area of the terminal may be realized by physical keys, virtual keys, sensors or a screen.

For example, if the terminal uses a curved screen, the edge touch area of the terminal can be realized by the edge screen of the curved screen. Taking a capacitive touch screen as an example for illustration, when the finger of the user touches the edge touch screen, the capacitance of the contact is changed, so that the oscillator frequency related with the capacitance is changed, the touch position can be determined by measuring the change of the oscillator frequency, and then the operation information of the user at the edge touch area of the terminal can be acquired.

Or, as another example, with regard to the edge touch area of the terminal having no curved screen, its operation can be realized by a physical key, a virtual key or a sensor. If a physical key for adjusting the volume is at the edge of the terminal, taking the physical key for adjusting the volume in the terminal as an example for illustration, when the finger of the user presses the physical key for adjusting the volume, the terminal may learn that which key the user has pressed, the key used for turning up the volume or the key used for turning down the volume, thereby acquiring the operation information of the user at the edge touch area of the terminal. If virtual keys with certain functions are at the edge of the terminal, taking the virtual keys on the terminal as an example, when the virtual keys are capacitive virtual keys, the terminal judges which virtual key the user touches via the capacitance of the capacitive virtual keys. Specifically, the finger and an electrode plate in the capacitive virtual key may form a capacitor when the user touches a capacitive virtual key, and the terminal detects the change of the capacitance to determine the touch position of the user so as to determine which virtual key the user touches and then acquire the operation information of the user at the edge touch area of the terminal. If sensors with certain functions are at the edge of the terminal, taking the sensors which are pressure sensors on the terminal as an example, when the user presses a pressure sensor, semiconductor deformation pressure is formed on the flaky surface of the pressure sensor, the flaky surface is deformed by pressing to produce a piezoelectric impedance effect, the change of the impedance is converted into an electrical signal, and the terminal can determine which pressure sensor the user presses or which position on the pressure sensor the user presses after acquiring the electrical signal, then determine the pressure sensor of which function the user presses and acquire the operation information of the user at the edge touch area of the terminal. Further, the sensors with certain functions at the edge of the terminal may also be optical inductors.

Specifically, acquiring operation information of a user operated at an edge touch area of the terminal means acquiring operation information of the user on a valid area of the edge touch area of the terminal. Only the operation in the valid area can fulfill the purpose of displaying the desktop icon hidden in the terminal via the screen of the terminal.

For example, if the terminal uses a curved screen, when the operation information of the user is acquired using the edge screen of the curved screen at the edge touch area of the terminal, the valid area of the edge screen is a screen edge area that the thumb of the user can click or touch when the user naturally holds the terminal. For example, if a physical key for adjusting the volume is at the edge of the terminal, when the operation information of the user is acquired using the physical key for adjusting the volume at the edge touch area of the terminal, the valid area is the one where the physical key for adjusting the volume is located; if a virtual key with a certain function is at the edge of the terminal, when the operation information of the user is acquired using the virtual key at the edge touch area of the terminal, the valid area is the one where the virtual key is located; and if a sensor with a certain function is at the edge of the terminal, when the operation information of the user is acquired using the sensor at the edge touch area of the terminal, the valid area is the one where the sensor is located.

S202, displaying a desktop icon hidden in the terminal via a screen of the terminal according to the operation information of the user at the edge touch area of the terminal.

Specifically, the user operates on the edge touch area of the terminal, and the terminal can display the desktop icon hidden in the terminal via the screen thereof.

In the embodiment of the present disclosure, the desktop icons hidden in the terminal include ones not displayed in the desktop of the terminal and the terminal still saves the contents of files, pictures, videos or disclosures and the like corresponding to the desktop icons. However, in the process of using the terminal, the user still can find the contents corresponding to the hidden desktop icons by some complex operation, e.g., using an disclosure management menu, a setting menu and the like.

Displaying a desktop icon hidden in the terminal via a screen of the terminal according to the operation information of the user at the edge touch area of the terminal specifically includes: detecting whether the operation information of the user at the edge touch area of the terminal is specified operation information for displaying the desktop icon hidden in the terminal; and if detecting that the operation information of the user at the edge touch area of the terminal is the specified operation information for displaying the desktop icon hidden in the terminal, displaying the desktop icon hidden in the terminal via the screen of the terminal.

Otherwise, if detecting that the operation information of the user at the edge touch area of the terminal is not the specified operation information for displaying the desktop icon hidden in the terminal, the hidden desktop icon is not displayed, and the hidden state of the hidden desktop icon is kept.

Specifically, the specified operation information for displaying the desktop icon hidden in the terminal is to judge whether the operation of the user in the valid area of the terminal can trigger the terminal to display the desktop icon hidden in the terminal via the screen.

For example, if the preset specified operation information for displaying the desktop icon hidden in the terminal is upward sliding in the valid area, after the terminal acquires the operation information of the user at the edge touch area of the terminal, the terminal judges whether the operation information of the user at the edge touch area of the terminal is upward sliding. If the operation information of the user at the edge touch area of the terminal is upward sliding, the terminal can display the hidden desktop icon via the screen thereof. Otherwise, if the operation information of the user at the edge touch area of the terminal is not upward sliding, the terminal keeps the hidden state of the hidden desktop icon, and does not execute the operation of displaying the desktop icon hidden in the terminal.

The technical solution of the embodiment of the present disclosure has the following advantages: in the embodiment of the present disclosure, operation information of a user at an edge touch area of the terminal is acquired, and then a desktop icon hidden in the terminal is displayed via a screen of the terminal according to the operation information of the user at the edge touch area of the terminal. In the embodiment of the present disclosure, after a user sets a private mode for some private contents, he does not need to change the running mode of the terminal or tediously input an unlocking password but only needs to carry out simple operation at the edge touch area of the terminal, and then the terminal displays desktop icons of these user's private contents hidden in the terminal via the screen, so the operation is simple and convenient and is not easily perceived by others. Hence, the embodiment of the present disclosure solves the problem of low operation efficiency caused by setting a private mode for user's private contents in the prior art, is simple and convenient in operation, and improves the operation efficiency.

### Embodiment 3

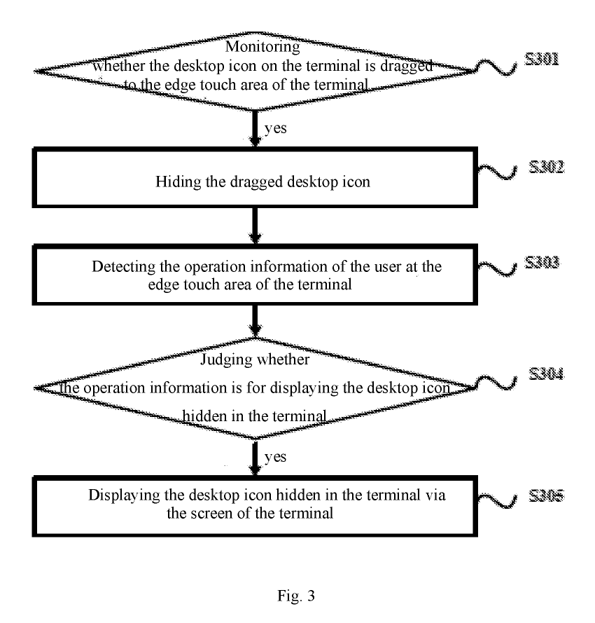

Based on the control methods for a terminal provided by embodiment 1 and embodiment 2 above, the embodiment of the present disclosure further provides a specific implementation for implementing the above method embodiments. Please refer to FIG. 3, which is a flow schematic diagram of embodiment 3 of a control method for a terminal provided by an embodiment of the present disclosure. As shown in FIG. 3, the method specifically may include S301˜S305.

S301, monitoring whether the desktop icon on the terminal is dragged to the edge touch area of the terminal.

S302, if so, hiding the dragged desktop icon.

S303, detecting the operation information of the user at the edge touch area of the terminal.

S304, judging whether the operation information of the user at the edge touch area of the terminal is specified operation information for displaying the desktop icon hidden in the terminal.

S305, if so, displaying the desktop icon hidden in the terminal via the screen of the terminal.

Specifically, if the operation information of the user at the edge touch area of the terminal is not the specified operation information for displaying the desktop icon hidden in the terminal, the state of the desktop icon hidden in the terminal is kept, and the operation of displaying the desktop icon hidden in the terminal via the screen of the terminal is not executed.

Specifically, after displaying the desktop icon hidden in the terminal via the screen of the terminal, the method may further include:

detecting the operation information of the user at the edge touch area of the terminal; and

if the operation information of the user at the edge touch area of the terminal is specified operation information for hiding the specified desktop icon, hiding the specified desktop icon.

Because this embodiment is a specific implementation of FIG. 1 and FIG. 2, for the parts not described in detail in this embodiment, reference may be made to relevant descriptions of FIG. 1 and FIG. 2.

The technical solution of the embodiment of the present disclosure has the following advantages: in the embodiment of the present disclosure, whether the desktop icon on the terminal is dragged to the edge touch area of the terminal is monitored, and if so, the dragged desktop icon is hidden; the operation information of the user at the edge touch area of the terminal is detected, and if the operation information of the user at the edge touch area of the terminal is specified operation information for displaying the desktop icon hidden in the terminal, the desktop icon hidden in the terminal is displayed via the screen of the terminal. In the embodiment of the present disclosure, based on simple operation at the edge touch area of the terminal, the desktop icon corresponding to user's private content can be hidden in the terminal, and the desktop icon corresponding to the hidden content in the terminal can also be displayed via the screen of the terminal; thus, no matter the user sets a private mode for the private content or opens the hidden content, he does not need to change the running mode of the terminal or to carry out tedious setting or to input an unlocking password, so the operation is simple and convenient and is not easily perceived by others; further, the problem of low operation efficiency caused by setting a private mode for user's private content in the prior art is solved, and the operation efficiency is improved.

### Embodiment 4

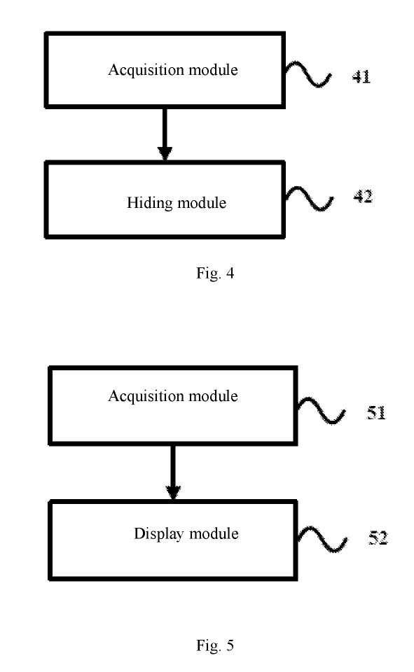

Based on the control method for a terminal provided by embodiment 1 above, the embodiment of the present disclosure further provides a device embodiment for implementing the steps and the methods in the above method embodiment. Please refer to FIG. 4, which is a structural schematic diagram of embodiment 1 of a terminal provided by an embodiment of the present disclosure. As shown in FIG. 4, the terminal includes an acquisition module 41 and a hiding module 42.

The acquisition module 41 is used for acquiring operation information of a user operated at an edge touch area of the terminal.

The hiding module 42 is used for hiding a specified desktop icon according to the operation information of the user at the edge touch area of the terminal.

Specifically, the acquisition module 41 is specifically used for monitoring whether the desktop icon on the terminal is dragged to the edge touch area of the terminal; and the hiding module 42 is specifically used for, if monitoring that the desktop icon on the terminal is dragged to the edge touch area of the terminal, hiding the dragged desktop icon.

Specifically, the acquisition module 41 is further specifically used for detecting whether the operation information of the user at the edge touch area of the terminal is specified operation information for hiding the specified desktop icon; and the hiding module 42 is further specifically used for, if detecting that the operation information of the user at the edge touch area of the terminal is the specified operation information for hiding the specified desktop icon, hiding the specified desktop icon.

Specifically, the edge touch area of the terminal includes an edge touch area of at least one side on the terminal.

Specifically, the operation information of the user at the edge touch area of the terminal includes: sliding operation information of the user at the edge touch area of the terminal; or clicking operation information of the user at the edge touch area of the terminal; or pressing operation information of the user at the edge touch area of the terminal.

Because the units in this embodiment can execute the method shown in FIG. 1, for the parts not described in detail in this embodiment, reference may be made to relevant description of FIG. 1.

The technical solution of the embodiment of the present disclosure has the following advantages: in the embodiment of the present disclosure, an acquisition module in the terminal acquires operation information of a user at an edge touch area of the terminal, and then a hiding module in the terminal hides a specified desktop icon according to the operation information of the user at the edge touch area of the terminal. In the embodiment of the present disclosure, when a user sets a private mode for some private contents, he only needs to carry out simple operation at the edge touch area of the terminal, and then the terminal hides the desktop icons corresponding to these user's private contents therein; thus, the user can simply and quickly set a private mode for some private contents, and the desktop icons corresponding to these contents are simultaneously guaranteed not to be perceived by other users. Hence, the embodiment of the present disclosure solves the problem of low operation efficiency caused by setting a private mode for user's private contents in the prior art, is simple and convenient in operation, and improves the operation efficiency.

### Embodiment 5

Based on the control method for a terminal according to the above embodiment 2, the embodiment of the present disclosure further provides a device embodiment for implementing the steps and the methods in the above method embodiment. Please refer to FIG. 5, which is a structural schematic diagram of embodiment 2 of a terminal provided by an embodiment of the present disclosure. As shown in FIG. 5, the terminal includes an acquisition module 51 and a display module 52.

The acquisition module 51 is used for acquiring operation information of a user operated at an edge touch area of the terminal.

The display module 52 is used for displaying a desktop icon hidden in the terminal via a screen of the terminal according to the operation information of the user at the edge touch area of the terminal.

The display module 52 is specifically used for detecting whether the operation information of the user at the edge touch area of the terminal is specified operation information for displaying the desktop icon hidden in the terminal; and if detecting that the operation information of the user at the edge touch area of the terminal is the specified operation information for displaying the desktop icon hidden in the terminal, displaying the desktop icon hidden in the terminal via the screen of the terminal.

Specifically, the edge touch area of the terminal includes an edge touch area of at least one side on the terminal.

Specifically, the operation information of the user at the edge touch area of the terminal includes: sliding operation information of the user at the edge touch area of the terminal; or clicking operation information of the user at the edge touch area of the terminal; or pressing operation information of the user at the edge touch area of the terminal.

Because the units in this embodiment can execute the method shown in FIG. 2, for the parts not described in detail in this embodiment, reference may be made to relevant description of FIG. 2.

The technical solution of the embodiment of the present disclosure has the following advantages: in the embodiment of the present disclosure, an acquisition module in the terminal acquires operation information of a user at an edge touch area of the terminal, and then a display module in the terminal displays a desktop icon hidden in the terminal via a screen of the terminal according to the operation information of the user at the edge touch area of the terminal. In the embodiment of the present disclosure, after a user sets a private mode for some private contents, he does not need to change the running mode of the terminal or tediously input an unlocking password but only needs to carry out simple operation at the edge touch area of the terminal, and then the terminal displays desktop icons of these user's private contents hidden in the terminal via the screen, so the operation is simple and convenient and is not easily perceived by others. Hence, the embodiment of the present disclosure solves the problem of low operation efficiency caused by setting a private mode for user's private contents in the prior art, is simple and convenient in operation, and improves the operation efficiency.

### Embodiment 6

The embodiment of the present disclosure provides a non-volatile computer storage medium, the computer storage medium stores a computer executable instruction, and the computer executable instruction can execute the processing method in embodiment 1 or 3 above.

### Embodiment 7

The embodiment of the present disclosure provides a non-volatile computer storage medium, the computer storage medium stores a computer executable instruction, and the computer executable instruction can execute the processing method in embodiment 2 or 3 above.

### Embodiment 8

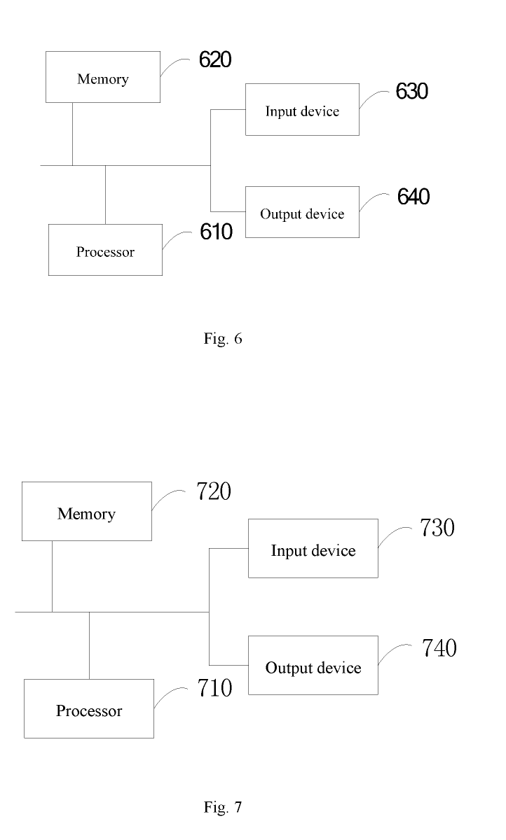

FIG. 6 is a schematic diagram of a hardware structure of a terminal for executing a control method for the terminal provided by an embodiment of the present disclosure. As shown in FIG. 6, the terminal includes one or more processors 610 and a memory 620. One processor 610 is taken as an example in FIG. 6. The terminal may further include an input device 630 and an output device 640.

The processor 610, the memory 620, the input device 630 and the output device 640 can be connected via a bus or in other mode, taking bus connection as an example in FIG. 6.

The memory 620 serving as a non-volatile computer readable storage medium can be used for storing non-volatile software programs, non-volatile computer executable programs and modules. The processor 610 runs the non-volatile software programs, instructions and modules stored in the memory 620 to execute various functional disclosures and data processing of the terminal, i.e., to implement the processing method in the above method embodiment.

The memory 620 may include a program storage area and a data storage area, wherein the program storage area can store an operating system and an disclosure program required by at least one function; and the data storage area can store data and the like. Moreover, the memory 620 may include a high-speed random access memory, and may also include a non-volatile memory, e.g., at least one disk storage device, a flash device or other non-volatile solid-state storage device. In some embodiments, the memory 620 may optionally include memories arranged remotely relative to the processor 610, and these remote memories can be connected to the processing device via a network. The example of the network includes but not limited to the internet, an intranet, a local area network, a mobile communication network and a combination thereof.

The input device 630 can receive input digit or character information and generate signal input. The output device 640 may include display equipment such as a display screen or the like.

The one or more modules are stored in the memory 620, and are executed by the one or more processors 610 to execute: acquiring operation information of a user operated at an edge touch area of a terminal; and displaying a desktop icon hidden in the terminal via a screen of the terminal according to the operation information of the user at the edge touch area of the terminal.

In a possible implementation, acquiring operation information of a user operated at an edge touch area of a terminal includes: monitoring whether the desktop icon on the terminal is dragged to the edge touch area of the terminal; and hiding a specified desktop icon according to the operation information of the user at the edge touch area of the terminal includes: if monitoring that the desktop icon on the terminal is dragged to the edge touch area of the terminal, hiding the dragged desktop icon.

In a possible implementation, acquiring operation information of a user operated at an edge touch area of the terminal includes: detecting whether the operation information of the user at the edge touch area of the terminal is specified operation information for hiding the specified desktop icon; and hiding a specified desktop icon according to the operation information of the user at the edge touch area of the terminal includes: if detecting that the operation information of the user at the edge touch area of the terminal is the specified operation information for hiding the specified desktop icon, hiding the specified desktop icon.

In a possible implementation, the edge touch area of the terminal includes an edge touch area of at least one side on the terminal.

In a possible implementation, the operation information of the user at the edge touch area of the terminal includes: operation information generated after sliding operation of the user at the edge touch area of the terminal; or operation information generated after clicking operation of the user at the edge touch area of the terminal; or operation information generated after pressing operation of the user at the edge touch area of the terminal.

The above product can execute the method provided by embodiment 1 or 3 of the present disclosure, and has corresponding functional modules for executing the method and corresponding advantages. For the technical details not elaborated in this embodiment, reference may be made to the method provided by embodiment 1 or 3 of the present disclosure.

### Embodiment 9

FIG. 7 is a schematic diagram of a hardware structure of a terminal for executing a control method for the terminal provided by an embodiment of the present disclosure. As shown in FIG. 7, the terminal includes:

one or more processors 710 and a memory 720, taking one processor 710 as an example in FIG. 7. The terminal may further include an input device 730 and an output device 740.

The processor 710, the memory 720, the input device 730 and the output device 740 can be connected via a bus or in other mode, taking bus connection as an example in FIG. 7.

The memory 720 serving as a non-volatile computer readable storage medium can be used for storing non-volatile software programs, non-volatile computer executable programs and modules. The processor 710 runs the non-volatile software programs, instructions and modules stored in the memory 720 to execute various functional disclosures and data processing of the terminal, i.e., to implement the processing method in the above method embodiment.

The memory 720 may include a program storage area and a data storage area, wherein the program storage area can store an operating system and an disclosure program required by at least one function; and the data storage area can store data and the like. Moreover, the memory 720 may include a high-speed random access memory, and may also include a non-volatile memory, e.g., at least one disk storage device, a flash device or other non-volatile solid-state storage device. In some embodiments, the memory 720 may optionally include memories arranged remotely relative to the processor 710, and these remote memories can be connected to the processing device via a network. The example of the network includes but not limited to the internet, an intranet, a local area network, a mobile communication network and a combination thereof.

The input device 730 can receive input digit or character information and generate signal input. The output device 740 may include display equipment such as a display screen or the like.

The one or more modules are stored in the memory 720, and are executed by the one or more processors 710 to execute: acquiring operation information of a user operated at an edge touch area of a terminal; and displaying a desktop icon hidden in the terminal via a screen of the terminal according to the operation information of the user at the edge touch area of the terminal.

In a possible implementation, displaying a desktop icon hidden in the terminal via a screen of the terminal according to the operation information of the user at the edge touch area of the terminal includes: detecting whether the operation information of the user at the edge touch area of the terminal is specified operation information for displaying the desktop icon hidden in the terminal; and if detecting that the operation information of the user at the edge touch area of the terminal is the specified operation information for displaying the desktop icon hidden in the terminal, displaying the desktop icon hidden in the terminal via the screen of the terminal.

In a possible implementation, the edge touch area of the terminal includes an edge touch area of at least one side on the terminal.

In a possible implementation, the operation information of the user at the edge touch area of the terminal includes: operation information generated after sliding operation of the user at the edge touch area of the terminal; or operation information generated after clicking operation of the user at the edge touch area of the terminal; or operation information generated after pressing operation of the user at the edge touch area of the terminal.

The above product can execute the method provided by embodiment 2 or 3 of the present disclosure, and has corresponding functional modules for executing the method and corresponding advantages. For the technical details not elaborated in this embodiment, reference may be made to the method provided by embodiment 2 or 3 of the present disclosure.

The terminal in the embodiments of the present disclosure exists in multiple forms, including but not limited to:

Mobile communication equipment: the equipment is characterized by having a mobile communication function, and having the main goals of providing voice and data communication. The terminal includes: a smart phone (e.g., iPhone), a multimedia phone, a functional phone, a low-end phone, etc.

Ultra-mobile personal computer equipment: the equipment belongs to the scope of personal computers, has computing and processing functions, and generally also has mobile internet characteristic. The terminal includes PDA, MID, UMPC equipment, etc., e.g. iPad.

Portable entertainment equipment: the equipment can display and play multimedia contents. The equipment includes audio and video players (e.g., iPod), handheld game players, electronic books, intelligent toys and portable vehicle-mounted navigation equipment.

Server: equipment for providing computing services, including a processor, a hard disk, a memory, a system bus, etc., wherein the architecture of the server is similar to that of a general computer, but the server has higher requirements for processing capability, stability, reliability, security, expandability, manageability and the like because it needs to provide high-reliability services.

Other electronic devices with data interaction functions.

The above-described device embodiments are only exemplary, wherein the units illustrated as separate components may be or may not be physically separated, and the components displayed as units may be or may not be physical units, that is to say, the components may be positioned at one place or may also be distributed on a plurality of network units. The objectives of the solutions of the embodiments may be fulfilled by selecting part of or all of the modules according to actual needs.

Upon the descriptions of the above implementations, those skilled in the art can clearly learn that each implementation can be realized by means of software and a general hardware platform, and of course, can be realized via hardware. Based on such an understanding, the above technical solutions substantially or the parts making contribution to relevant technologies may be embodied in the form of a software product, and the computer software product can be stored in a computer readable storage medium, such as an ROM/RAM, a magnetic disk, optical disk, etc., which includes a plurality of instructions enabling computer equipment (which may be a personal computer, a server, a network equipment or the like) to execute the method in each embodiment or some part of each embodiment.

Finally, it should be noted that the above embodiments are merely used for illustrating the technical solutions of the present disclosure, rather than limiting the present disclosure; though the present disclosure is illustrated in detail with reference to the aforementioned embodiments, it should be understood by those of ordinary skill in the art that modifications may still be made to the technical solutions disclosed in the aforementioned embodiments, or equivalent substitutions may be made to a part of technical characteristics thereof; and these modifications or substitutions do not make the nature of the corresponding technical solutions depart from the spirit and scope of the technical solutions of the embodiments of the present disclosure.

### INDUSTRIAL APPLICABILITY

According to the control method for the terminal provided by the embodiments of the present disclosure, by acquiring operation information of a user operated at an edge touch area of the terminal and hiding a specified desktop icon according to the operation information of the user at the edge touch area of the terminal, when a user sets a private mode for some private contents, he only needs to carry out simple operation at the edge touch area of the terminal, and then the terminal hides the desktop icons corresponding to these user's private contents therein; thus, the user can simply and quickly set a private mode for some private contents, the operation is simple and convenient, and the operation efficiency is improved.

By acquiring operation information of a user operated at an edge touch area of the terminal and displaying a desktop icon hidden in the terminal via a screen of the terminal according to the operation information of the user at the edge touch area of the terminal, after a user sets a private mode for some private contents, he does not need to change the running mode of the terminal or tediously input an unlocking password but only needs to carry out simple operation at the edge touch area of the terminal, and then the terminal displays the desktop icons of these user's private contents hidden in the terminal via the screen, so that the operation is simple and convenient and the operation efficiency is improved.

1. A control method for a terminal, adapted to be used by a server, said method comprising:
acquiring operation information of a user operated at an edge touch area of the terminal; and
hiding a specified desktop icon according to the operation information of the user at the edge touch area of the terminal.

2. The method according to claim 1, wherein,
acquiring operation information of a user operated at an edge touch area of the terminal comprises: monitoring whether the desktop icon on the terminal is dragged to the edge touch area of the terminal; and
wherein hiding a specified desktop icon according to the operation information of the user at the edge touch area of the terminal comprises: if monitoring that the desktop icon on the terminal is dragged to the edge touch area of the terminal, hiding the dragged desktop icon.

3. The method according to claim 1, wherein,
acquiring operation information of a user operated at an edge touch area of the terminal comprises: detecting whether the operation information of the user at the edge touch area of the terminal is specified operation information for hiding the specified desktop icon; and
wherein hiding a specified desktop icon according to the operation information of the user at the edge touch area of the terminal comprises: if detecting that the operation information of the user at the edge touch area of the terminal is the specified operation information for hiding the specified desktop icon, hiding the specified desktop icon.

4. The method according to claim 1, wherein the edge touch area of the terminal comprises an edge touch area of at least one side on the terminal.

5. The method according to claim 3, wherein the operation information of the user at the edge touch area of the terminal comprises:
operation information generated after sliding operation of the user at the edge touch area of the terminal; or
operation information generated after clicking operation of the user at the edge touch area of the terminal; or
operation information generated after pressing operation of the user at the edge touch area of the terminal.

6. A control method for a terminal, adapted to be used by a server, said method comprising:
acquiring operation information of a user operated at an edge touch area of the terminal; and
displaying a desktop icon hidden in the terminal via a screen of the terminal, according to the operation information of the user at the edge touch area of the terminal.

7. The method according to claim 6, wherein displaying a desktop icon hidden in the terminal via a screen of the terminal according to the operation information of the user at the edge touch area of the terminal comprises:
detecting whether the operation information of the user at the edge touch area of the terminal is specified operation information for displaying the desktop icon hidden in the terminal; and
if detecting that the operation information of the user at the edge touch area of the terminal is the specified operation information for displaying the desktop icon hidden in the terminal, displaying the desktop icon hidden in the terminal via the screen of the terminal.

8. The method according to claim 6, wherein the edge touch area of the terminal comprises an edge touch area of at least one side on the terminal.

9. The method according to claim 6, wherein the operation information of the user at the edge touch area of the terminal comprises:
operation information generated after sliding operation of the user at the edge touch area of the terminal; or
operation information generated after clicking operation of the user at the edge touch area of the terminal; or
operation information generated after pressing operation of the user at the edge touch area of the terminal.

10. A terminal, comprising:
at least one processor; and
a memory in communication connection with the at least one processor; wherein,
the memory stores an instruction which can be executed by the at least one processor, and the instruction is executed by the at least one processor, so that the at least one processor can: acquire operation information of a user at an edge touch area of the terminal; and
display a desktop icon hidden in the terminal via a screen of the terminal according to the operation information of the user at the edge touch area of the terminal.
